(19) United States
(12) Patent Application Publication
(10) Pub. No.: US 2006/0077129 A1
(43) Pub. Date: Apr. 13, 2006

(54) Plasma display device

(76) Inventors: Ki-Jung Kim, Suwon-si (KR); Tae-Kyoung Kang, Suwon-si (KR)

Correspondence Address: Robert E. Bushnell;Suite 300, 1522 K Street, N.W., Washington, DC, 20005, US

(21) Appl. No.: 11/174,735

(22) Filed: Jul. 6, 2005

(30) Foreign Application Priority Data
Oct. 11, 2004 (KR) 10-2004-0080873

(51) Int. Cl. G09G 3/28

(52) U.S. Cl. 345/60

(57) ABSTRACT

Breakage of an IC included in a plasma display device can be prevented by a plasma display device including: a Plasma Display Panel (PDP); a chassis base attached the PDP on one side thereof and attached to a printed circuit board assembly on another side thereof; an Integrated Circuit (IC) package including an IC coupled between an electrode from the PDP and the printed circuit board assembly; and a cover plate attached to a chassis base interposing the IC package; and at least one of the chassis base and the cover plate includes at least one slit arranged in a vicinity of a portion corresponding to the IC.

### CLAIM OF PRIORITY

This application makes reference to, incorporates the same herein, and claims all benefits accruing under 35 U.S.C. §119 from an application for PLASMA DISPLAY DEVICE earlier filed in the Korean Intellectual Property Office on 11 Oct. 2004 and there duly assigned Ser. No. 10-2004-0080873.

### BACKGROUND OF THE INVENTION

1. Field of the Invention

The present invention relates to a plasma display device. More particularly, the present invention relates to a plasma display device that prevents breakage of an Integrated Circuit (IC) provided in a Tape Carrier Package (TCP).

2. Description of the Related Art

A plasma display device is an apparatus that displays an image on a Plasma Display Panel (PDP) using a plasma generated by a gas discharge.

The plasma display device includes the PDP, a chassis base supporting the PDP, and a plurality of Printed circuit Board Assemblies (PBAs) attached to the chassis base on a side opposite to the PDP. The PBAs are connected to display electrodes or address electrodes, e.g., through a Flexible Printed Circuit (FPC) and a connector.

Since the PDP includes two glass substrates attached to each other at their surfaces and discharge spaces formed therebetween, such a PDP has poor mechanical strength against an impact. The PDP produces substantial heat during operation, and accordingly, a thermal conduction sheet is provided at its rear side. The thermal conduction sheet conducts the heat produced by the PDP to spread it in planar directions.

The chassis base is formed of a metallic material having sufficient mechanical strength to support the PDP, and is attached to the PDP through a double-sided adhesive tape. In addition to reinforcing the strength of the PDP, the chassis base supports the PBAs, dissipates the heat of the PDP, and prevents ElectroMagnetic Interference (EMI).

The PDP supported by the chassis base addresses discharge cells and discharges the addressed discharge cells to realize a desired image, through address electrodes and display electrodes provided therein. The electrodes provided in the PDP are drawn out through the FPC, and the FPC is connected to the PBA.

Therefore, the PDP is controlled by control signals of the PBA.

On the other hand, the address electrodes are connected to a PBA through an FPC and a TCP, in order to receive an address voltage pulse. Such a TCP is provided with a driver IC. In order to express grayscales in the PDP, the driver IC repeatedly supplies an address voltage pulse to the address electrodes at a high frequency. Therefore, the driver IC produces a substantial amount of heat and EMI.

The driver IC is therefore provided with a heat dissipation mechanism disposed in a marginal region of the chassis base. That is, the driver IC provided by the TCP is disposed in the marginal region of the chassis base and supplied with a thermal grease. In addition, a cover plate is provided to the driver IC and supplied with a thermal conduction sheet. The cover plate is fixed to the chassis base by setscrews, and thus the TCP and driver ICs provided thereat are mounted on the chassis base.

When the number of driver ICs mounted on one TCP is decreased, the driver IC mounted at one TCP can be lengthened. A long driver IC can easily suffer breakage when closely assembled between the chassis base and the cover plate.

In addition, the PDP and the chassis base have respective thermal expansion coefficients. A difference of the thermal expansion coefficients can cause the assembly of the PDP and the chassis base to bend. The PDP is typically formed with a ratio of width (i.e., horizontal length) to height (i.e., vertical length) of about 16:9, and the bending of the assembly can be more severe in the horizontal direction than in the vertical direction. Due to the bending of the assembly, driver ICs disposed on both horizontal ends of the chassis base can suffer breakage more easily.

### SUMMARY OF THE INVENTION

The present invention has been made in an effort to provide a plasma display device having advantages of preventing breakage of an Integrated Circuit (IC) provided by a Tape Carrier Package (TCP).

An exemplary plasma display device according to an embodiment of the present invention includes: a Plasma Display Panel (PDP); a chassis base attached the PDP on one side thereof and attached to a printed circuit board assembly on another side thereof; an IC package including an IC coupled between an electrode from the PDP and the printed circuit board assembly; and a cover plate attached to a chassis base interposing the IC package; and at least one of the chassis base and the cover plate includes at least one slit arranged in a vicinity of a portion corresponding to the IC.

The chassis base preferably includes a reinforcing member arranged at a long edge along a long edge direction thereof.

The cover plate is preferably elongated along the long edge direction of the chassis base to cover a plurality of IC packages.

The IC is preferably rectangular in shape having a long edge and a short edge; the chassis base is preferably rectangular in shape having a long edge and a short edge; and the long edge of the IC is preferably arranged in parallel with the short edge of the chassis base.

The at least one slit is preferably arranged in parallel with a long edge of the driver IC and is preferably elongated from a central portion to an edge of the cover plate.

The at least one slit preferably includes a pair of slits respectively arranged on opposite sides of long edges of the IC.

The IC is preferably rectangular in shape having a long edge and a short edge; the chassis base is preferably rectangular in shape having a long edge and a short edge; and the long edge of the IC is preferably arranged in parallel with the long edge of the chassis base.

The at least one slit is preferably arranged in the cover plate and preferably has a horseshoe shape corresponding to a short edge and a pair of long edges of the IC.

The at least one slit is preferably arranged in parallel with a long edge of the IC and is preferably elongated from a central portion to an edge of the reinforcing member.

The at least one slit preferably includes a pair of slits respectively arranged on opposite sides of long edges of the IC.

The at least one slit is preferably arranged in the reinforcing member and preferably has a horseshoe shape corresponding to a short edge and a pair of long edges of the IC.

A plurality of ICs preferably correspond to each portion demarcated by the at least one slit.

At least one end of a portion demarcated by the at least one slit is preferably an open end.

The open end is preferably bent to protrude from a plane of the cover plate or the reinforcing member.

The IC package preferably includes a tape carrier package combined with the IC.

Such a slit or slits form the incision portion in the cover plate or the reinforcing member, and accordingly, the incision portion can become offset when forced by the IC between the reinforcing member and the cover plate.

That is, the pressure applied to the IC becomes constant due to the incision portion.

Therefore, breakage of the IC by an external force can be prevented.

In addition, breakage of the IC caused by bending of the chassis base due to the difference between thermal expansion coefficients of the PDP and the chassis base can be prevented.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a perspective view of a plasma display device according to a first embodiment of the present invention.

FIG. 2 is a sectional view along the line A-A of FIG. 1.

FIG. 3 is an exploded perspective view of FIG. 2 including a chassis base, a reinforcing member, a TCP, and a cover plate.

FIG. 4 is an exploded perspective view of a chassis base, a reinforcing member, a TCP, and a cover plate according to a second embodiment of the present invention.

FIG. 5 is a sectional view along the line A-A of FIG. 1 according to a third embodiment of the present invention.

FIG. 6 is an exploded perspective view of FIG. 5 including a chassis base, a reinforcing member, a TCP, and a cover plate.

FIG. 7 is an exploded perspective view of a chassis base, a reinforcing member, a TCP, and a cover plate according to a fourth embodiment of the present invention.

### DETAILED DESCRIPTION OF THE INVENTION

Embodiments of the present invention are described in detail below with reference to the accompanying drawings.

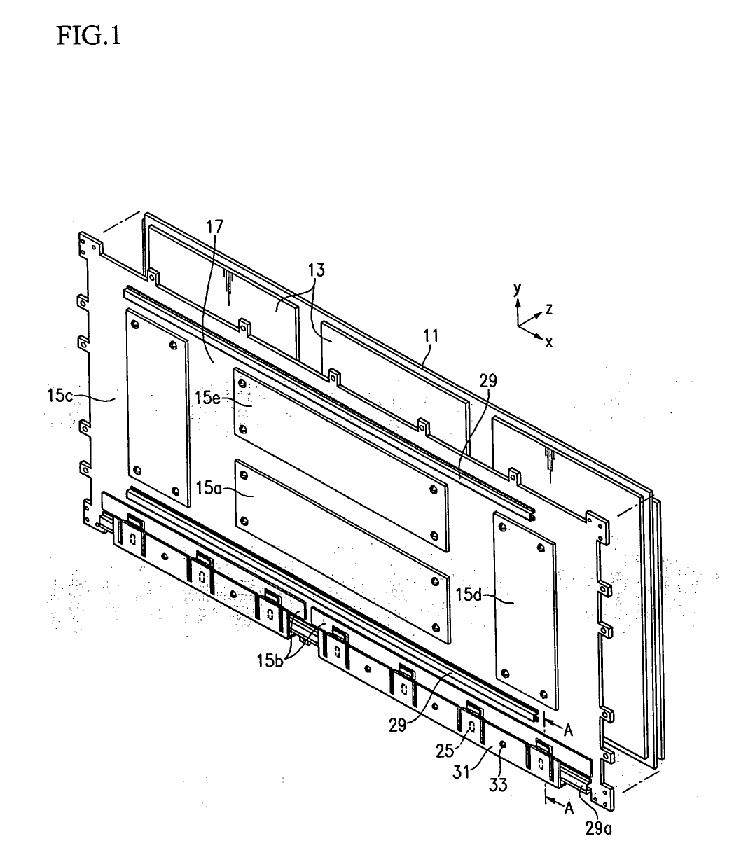

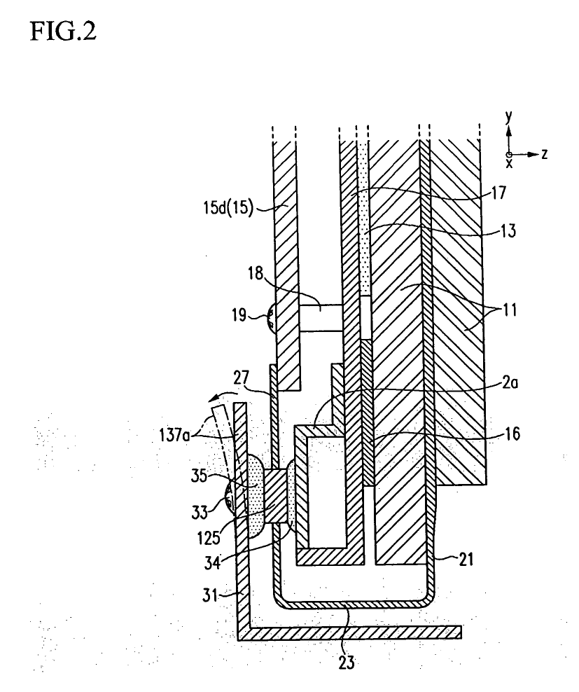

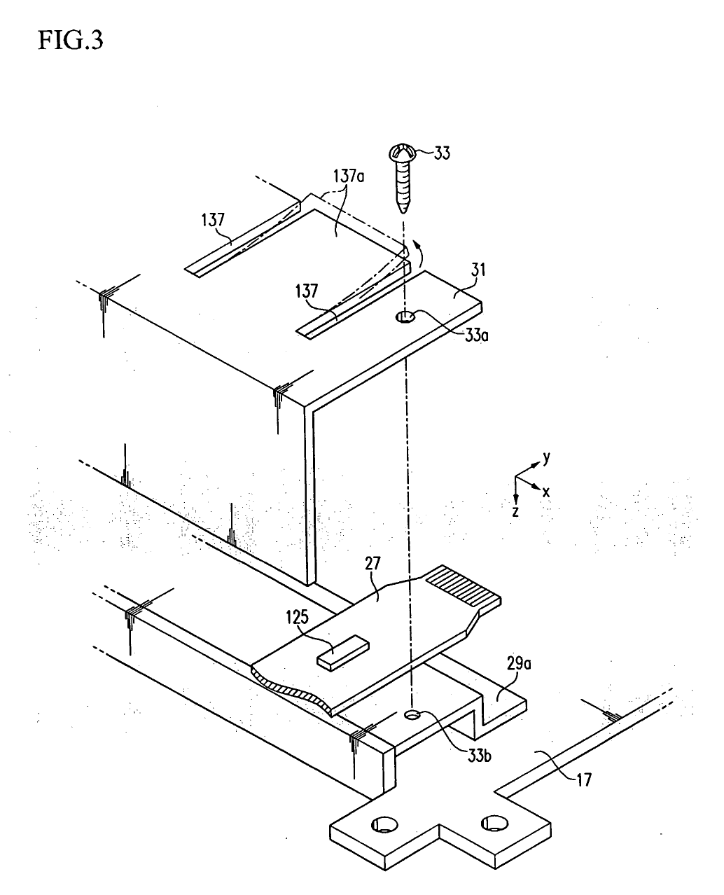

FIG. 1 is a perspective view of a plasma display device according to a first embodiment of the present invention, FIG. 2 is a sectional view along the line A-A of FIG. 1, and FIG. 3 is an exploded perspective view of FIG. 2 including a chassis base, a reinforcing member, a TCP, and a cover plate.

The plasma display device includes a PDP 11 for displaying an image using a gas discharge, heat dissipation sheets 13, PBAs 15a to 15e (hereinafter, the PBAs 15a to 15e can collectively or respectively be referred to by reference numeral 15) electrically connected to the PDP 11 so as to drive it, and a chassis base 17 mounted with and supporting the PDP 11 at its front side through a double-sided adhesive tape 16 and mounted with and supporting the PBAs 15 at its rear side.

The heat dissipation sheet 13 is attached to the rear of the PDP 11 so as to conduct and spread heat generated by the gas discharge of the PDP 11 in planar directions (i.e., directions on the x-y plane shown in FIG. 1). The heat dissipation sheet 13 can be made of a heat dissipation material having sufficient thermal conductivity such as acryl, graphite, metal, or carbon nano-tubes.

The PBA 15 can be attached to a boss 18 of the chassis base 17 by a setscrew 19 (refer to FIG. 2). An image processing/controlling board 15a among the PBAs 15 receives an external video signal, generates control signals for driving address electrodes 21 and display electrodes (not shown), and respectively supplies them to an address driving board 15b, a scan driving board 15c, and a sustain driving board 15d. A power supply board 15e supplies electric power required for driving the plasma display device.

For driving the PDP 11, the address driving board 15b, the scan driving board 15c, and the sustain driving board 15d are connected to corresponding electrodes of the PDP 11 via respective FPCs 23. For a representative example, the connection between the address driving board 15b and the PDP 11 via the FPC 23 is illustrated in the drawings and hereinafter described. Although not shown in the drawings in detail, the scan driving board 15c and the sustain driving board 15d are also respectively connected to scan electrodes (not shown) and sustain electrodes (not shown) of the PDP 11 via an FPC (not shown).

A driver IC 125 is coupled between the address driving board 15b and the address electrodes 21 of the PDP 11. The driver IC 125 selectively supplies an address voltage pulse to the address electrodes 21 of the PDP 11 by a control signal of the address driving board 15b. Discharge cells of the PDP 11 are then selected by a scan voltage pulse supplied to the scan electrodes and an address voltage pulse supplied to the address electrodes 21. Such a driver IC 125 for supplying the address voltage pulse can be realized by a driver IC package. For example, the driver IC 125 can be packaged into the FPC 23 to form a TCP 27. The TCP 27 is connected to the address driving board 15b at its input side, and is connected to the address electrode 21 of the PDP 11 via the FPC 23 at its output side.

The address electrodes 21 of the PDP 11 are drawn out externally via the FPC 23, and connected to the address driving board 15b via the TCP 27 and driver IC 125 disposed at an end of the chassis base 17.

The chassis base 17 can be formed by pressing a thin plate of a metallic material. The chassis base 17 must have sufficient mechanical strength to withstand twisting and bending forces. As shown in FIG. 2, the chassis base 17 can preferably be bent at its end to form an L-shaped cross-section, or can preferably be provided with a reinforcing member 29 (refer to FIG. 1). More preferably, according to the present embodiment, a reinforcing member 29a is added to a bent end of the chassis base 17 as shown in FIG. 2.

As shown in FIG. 1, the reinforcing member 29 can be formed at an appropriate position that does not cause any spatial interference with the PBAs 15 mounted on the rear side of the chassis base 17. In addition, the reinforcing member 29a can be formed at a marginal area of the chassis base 17. The reinforcing member 29a can support the driver IC 125 and the TCP 27. The driver IC 125 and the TCP 27 interconnect the address electrodes 21 of the PDP 11 drawn out from the front side of the chassis base 17 and the address driving board 15b attached to the rear side of the chassis base 17.

The chassis base 17 has a rectangular shape having its long edge in the x-axis direction and its short edge in the y-axis direction. The driver IC 125 also has a rectangular shape having long and short edges. The reinforcing member 29a can be extended along a long edge direction (i.e., the x-axis direction in the drawings) near a long edge of the chassis base 17.

A cover plate 31 is attached to the chassis base 17 interposing the TCP 27 and the driver IC 125. The cover plate 31 is fixed to the chassis base 17 (in more detail, to the reinforcing member 29a) by a setscrew 33, so as to fix the driver IC 125 to the chassis base 17. The cover plate 31 dissipates heat produced by the driver IC 125 during its operation. The cover plate 31 and the reinforcing member 29a are respectively provided with a penetration hole 33a and a threaded hole 33b for receiving the setscrew 33. Although the cover plate 31 can be elongated in the long edge direction (i.e., the x-axis direction) to cover a plurality of the TCPs 27 and the driver ICs 125 as shown in FIG. 1, it can also be separately provided to each set of the TCP 27 and the driver IC 125 disposed along the long edge (i.e., in the x-axis direction) of the chassis base 17. When the cover plate 31 is elongated along the long edge direction of the chassis base 17, the cover plate 31 can be easily atached to the chassis base 17 and can form a uniform combining force throughout the plurality of driver ICs 125.

For such reasons, according to an embodiment of the present invention, a reinforcing member 29a is provided at a long edge side end of the chassis base 17. The cover plate 31 is attached to the reinforcing member 29a. The driver IC 125 is disposed between the cover plate 31 and the reinforcing member 29a. A thermal grease 34 is applied between the driver IC 125 and the reinforcing member 29a, and a thermal conduction sheet 35 is disposed between the driver IC 125 and the cover plate 31. Therefore, when the driver IC 125 operates, heat caused thereby is conducted to the reinforcing member 29a and the cover plate 31 through the thermal grease 34 and the thermal conduction sheet 35 so as to be rapidly dissipated. When a plasma display device is not provided with such a reinforcing member 29a, the thermal grease 34 can be applied between the driver IC 125 and the chassis base 17.

As shown in FIG. 3, the driver IC 125 can be elongated on a TCP 27 to reduce the number thereof. For example, a TCP having two driver ICs (not shown) each provided with 96 output terminals and a TCP having one driver IC having 192 (or 256 or 384) output terminals can be compared. A driver IC having a greater number of output terminals is longer than a driver IC having a smaller number of output terminals. Therefore, the driver IC 125 is formed in a rectangular shape having long and short edges as shown in FIG. 3. Such a non-square rectangular-shaped driver IC 125 between the cover plate 31 and the chassis base 17 (or the reinforcing member 29a) can easily suffer breakage when a bending force is applied due to the bending of the chassis base 17.

In order to prevent such breakage, the chassis base 17 or the cover plate 31 is provided with one or more slits 137 at a position facing the driver IC 125. The slits 137 can be formed in one of or both the chassis base 17 and the cover plate 31. When the chassis base 17 is provided with the reinforcing member 29a, the slits 137 can be formed in one of or both the cover plate 31 and the reinforcing member 29a. An embodiment of the present invention is described hereinafter in connection with an exemplary case in which the slits 137 are formed in the cover plate 31 and/or the reinforcing member 29a.

When an excessive force is applied to the cover plate 31 and the reinforcing member 29a and accordingly to the driver IC 125 disposed therebetween, incision portion 137a formed in the cover plate 31 and/or the reinforcing member 29a by the slits 137 becomes slightly bent to be offset from the cover plate 31 and/or the reinforcing member 29a as shown in FIG. 2 and FIG. 3. That is, at least one end of the incision portion 137a demarcated by the slits 137 is formed as an open end. The open end is bent to protrude from a plane of the cover plate 31 or the reinforcing member 29a. Therefore, the incision portion 137a can prevent excessive external force from being applied to the driver IC 125, thereby preventing breakage of the driver IC 125.

In addition, even if a bending force is applied to the assembly of the PDP 11 and chassis base 17 due to a difference in thermal expansion coefficients of the PDP 11 and the chassis base 17, the slits 137 can absorb the difference in the thermal expansions. Furthermore, the slits 137 can prevent the bending force from being applied to the driver IC 125 because the incision portion 137a becomes offset from the plane of the cover plate 31 or the reinforcing member 29a. Therefore, it is difficult for the driver IC 125 having the long edge to suffer breakage. Such an effect will not be described in detail.

FIG. 2 and FIG. 3 illustrate a scheme according to a first embodiment of the present invention. As shown in the drawings, the driver IC 125 is provided on the TCP 27 with its long edge in parallel with a short edge of the chassis base 17. In order to protect such a driver IC 125, the slits 137 are formed in the cover plate 31, in parallel with the long edge of the driver IC 125 (i.e., along the y-axis direction in the drawings). The slits 137 are elongated from a central portion of the cover plate 31 to an edge thereof. The slits 137 can be formed at only one side of long edges of the driver IC 125. However, it is preferable that they are formed in pairs at opposite sides of the driver IC 125, such that the slits 137 can be respectively disposed on opposite sides of the long edges of the driver IC 125. The slits 137 form the incision portion 137a in the cover plate 31. As shown by the one-point chain lines in FIG. 2, the incision portion 137a can be bent to become slightly offset from the cover plate 31 by a biasing force of the driver IC 125, and therefore breakage of the driver IC 125 can be prevented due to a strong external force received from the cover plate 31 and due to a bending force caused by the difference in thermal expansion coefficients.

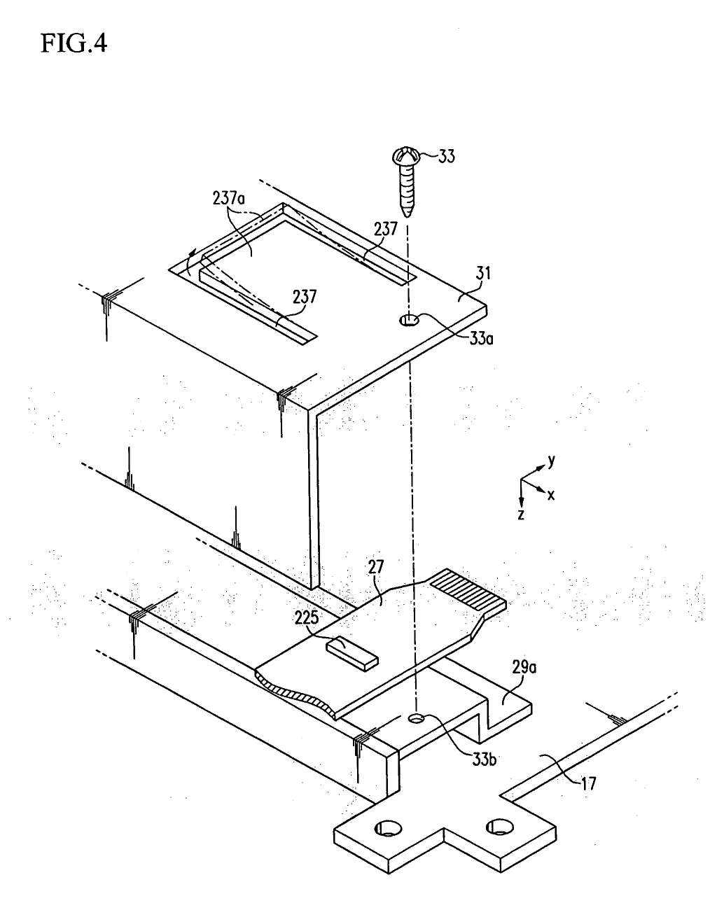

FIG. 4 relates to a second embodiment of the present invention, which has similar structural features, operation, and effect as the first embodiment, and hereinafter, the following description is focused only on features of the second embodiment that are different from the first embodiment.

The driver IC 225 is provided on the TCP 27 having its long edge in parallel with the long edge of the chassis base 17. In order to protect such a driver IC 225, slits 237 form an incision portion 237a in the cover plate 31, in a horseshoe shape corresponding to a short edge and a pair of long edges of the driver IC 225. Such slits 237 can be altered in shape to an L shape, when a side corresponding to the short edge of the driver IC is formed to reach an end of the cover plate 31. Considering that a larger bending force is applied to the long edge of the chassis base 17 (i.e., in the x-axis direction) than the short edge thereof (i.e., in the y-axis direction), such an arrangement of the driver IC 225 can increase the possibility of breakage of the driver IC 225. Therefore, the slits 237 and the incision portion 237a formed in such a position can more effectively prevent the breakage of the driver IC 225.

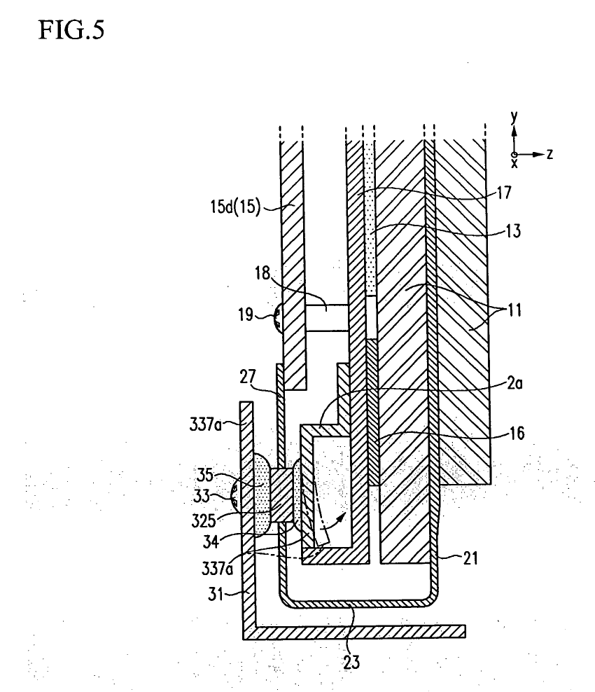

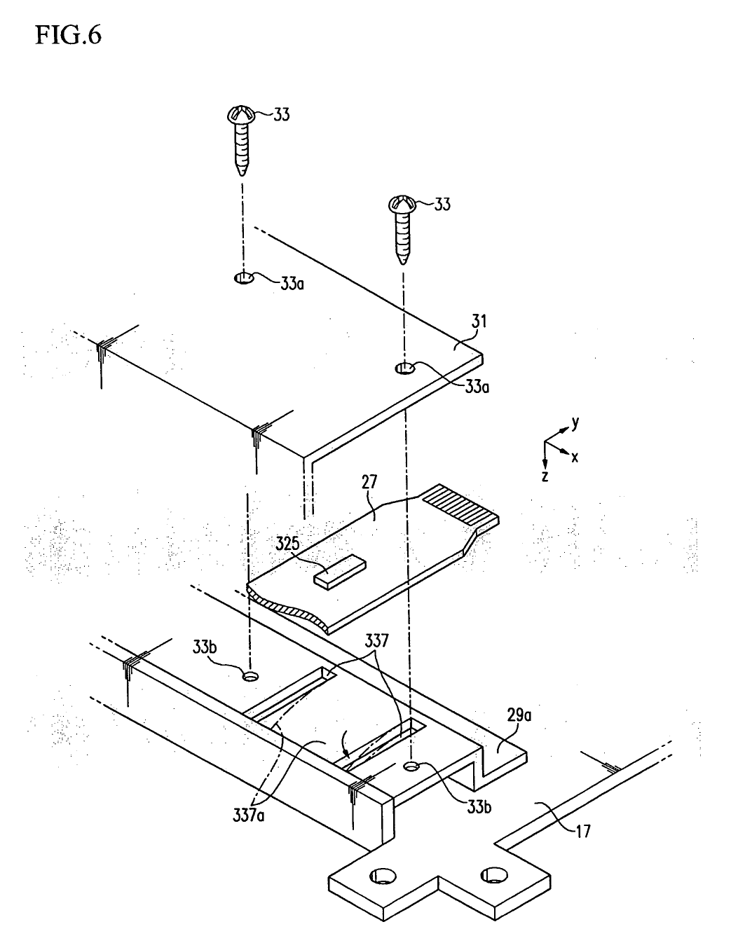

FIG. 5 and FIG. 6 relate to a third embodiment of the present invention, which has similar structural features, operation, and effect as the first embodiment, and hereinafter, the following description is focused only on features of the third embodiment different from the first embodiment.

The driver IC 325 is provided on the TCP 27 having its long edge in parallel with the short edge of the chassis base 17. In order to protect such a driver IC 325, slits 337 are formed in the reinforcing member 29a, in parallel with the long edge of the driver IC 325. The slits 337 are elongated from a central portion of the reinforcing member 29a to an edge thereof. The slits 337 can be formed on only one side of long edges of the driver IC 325. However, it is preferable that they are formed in pairs at opposite sides of the driver IC 325, such that each slit 337 can correspond to each long edge of the driver IC 125. An incision portion 337a is formed in the reinforcing member 29a by the slits 337. As shown by one-point chain lines in FIG. 5 and FIG. 6, the incision portion 337a can be bent to become slightly offset from the reinforcing member 29a by a biasing force of the driver IC 325, and therefore, the breakage of the driver IC 325 can be prevented due to a strong external force received from the reinforcing member 29a and due to a bending force caused by the difference in thermal expansion coefficients. Such slits 337 formed in the reinforcing member 29a can enable the incision portion 337a to become inwardly offset with respect to the chassis base 17, and accordingly can prevent interference with components mounted on the rear of the cover plate 31.

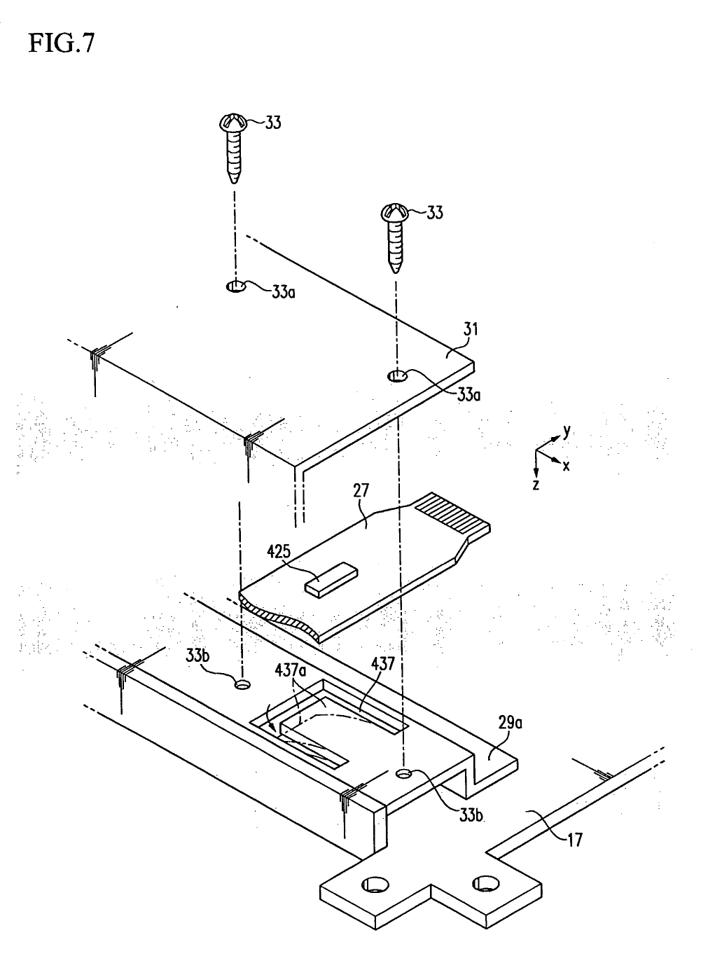

FIG. 7 relates to a fourth embodiment of the present invention, which has similar structural features, operation, and effect as the third embodiment, and hereinafter, the following description is focused on only features of the second embodiment that are different from the third embodiment.

The driver IC 425 is provided on the TCP 27 having its long edge in parallel with the long edge of the chassis base 17. In order to protect such a driver IC 425, slits 437 are formed in the reinforcing member 29a and form an incision portion 437a, in a horseshoe shape corresponding to one long edge and a pair of short edges of the driver IC 425. Such slits 437 can be altered in shape to an L shape, when a side corresponding to the long edge of the driver IC is formed to reach an end of the reinforcing member 29a.

As described above, according to a plasma display device of an embodiment of the present invention, a reinforcing member is provided at a long edge of a chassis base, and a cover plate is attached to the reinforcing member interposing a TCP provided with a driver IC. In addition, slits are formed in the reinforcing member or the cover plate in the vicinity of the driver IC such that an incision portion formed by the slits can become offset from the reinforcing member or the cover plate when the driver IC is forced by the cover plate. Therefore, breakage of the driver IC between the reinforcing member and the cover plate can be prevented. Furthermore, breakage of the driver IC can also be prevented due to the difference between thermal expansion coefficients of the PDP and the chassis base.

While the present invention has been described in connection with exemplary embodiments, it is to be understood that the present invention is not limited to these embodiments, but, on the contrary, the present invention is intended to cover various modifications and equivalent arrangements included within the spirit and scope of the appended claims.

What is claimed is:

1. A plasma display device, comprising:
a Plasma Display Panel (PDP);
a chassis base attached the PDP on one side thereof and attached to a printed circuit board assembly on another side thereof;
an Integrated Circuit (IC) package including an IC coupled between an electrode from the PDP and the printed circuit board assembly; and
a cover plate attached to a chassis base interposing the IC package;
wherein at least one of the chassis base and the cover plate includes at least one slit arranged in a vicinity of a portion corresponding to the IC.

2. The plasma display device of claim 1, wherein the chassis base comprises a reinforcing member arranged at a long edge along a long edge direction thereof.

3. The plasma display device of claim 2, wherein the cover plate is elongated along the long edge direction of the chassis base to cover a plurality of IC packages.

4. The plasma display device of claim 2, wherein:
the IC is rectangular in shape having a long edge and a short edge;
the chassis base is rectangular in shape having a long edge and a short edge; and
the long edge of the IC is arranged in parallel with the short edge of the chassis base.

5. The plasma display device of claim 4, wherein the at least one slit is arranged in parallel with a long edge of the driver IC and is elongated from a central portion to an edge of the cover plate.

6. The plasma display device of claim 5, wherein the at least one slit comprises a pair of slits respectively arranged on opposite sides of long edges of the IC.

7. The plasma display device of claim 2, wherein:
the IC is rectangular in shape having a long edge and a short edge;
the chassis base is rectangular in shape having a long edge and a short edge; and
the long edge of the IC is arranged in parallel with the long edge of the chassis base.

8. The plasma display device of claim 7, wherein the at least one slit is arranged in the cover plate and has a horseshoe shape corresponding to a short edge and a pair of long edges of the IC.

9. The plasma display device of claim 4, wherein the at least one slit is arranged in parallel with a long edge of the IC and is elongated from a central portion to an edge of the reinforcing member.

10. The plasma display device of claim 9, wherein the at least one slit comprises a pair of slits respectively arranged on opposite sides of long edges of the IC.

11. The plasma display device of claim 4, wherein the at least one slit is arranged in the reinforcing member and has a horseshoe shape corresponding to a short edge and a pair of long edges of the IC.

12. The plasma display device of claim 1, wherein a plurality of ICs correspond to each portion demarcated by the at least one slit.

13. The plasma display device of claim 1, wherein at least one end of a portion demarcated by the at least one slit is an open end.

14. The plasma display device of claim 13, wherein the open end is bent to protrude from a plane of the cover plate or the reinforcing member.

15. The plasma display device of claim 1, wherein the IC package comprises a tape carrier package combined with the IC.
